(19) United States
(12) Patent Application Publication
(10) Pub. No.: US 2003/0102817 A1
(43) Pub. Date: Jun. 5, 2003

(54) Liquid crystal display device employing cold cathode fluorescent tube type lamp

(76) Inventors: Hyeong-Suk Yoo, Seongnam-si (KR); Weon-Sik Oh, Osan-si (KR); Sung-Chul Kang, Seongnam-si (KR)

Correspondence Address: Michael A. Cantor, 55 Griffin South Road, Bloomfield, CT, 06002, US

(21) Appl. No.: 10/205,856

(22) Filed: Jul. 26, 2002

(30) Foreign Application Priority Data
Nov. 30, 2001 (KR) 2001-75236

(51) Int. Cl. H05B 41/16

(52) U.S. Cl. 315/246

(57) ABSTRACT

Disclosed are a cold cathode fluorescent tube type lamp and a liquid crystal display device using the same. One of two electrodes is disposed inside a lamp tube, and the other electrode is disposed outside the lamp tube. Discharging gas and fluorescent material are injected in the lamp tube. Therefore, the power consumption for generating light from the lamp is reduced, and the brightness non-uniformity between multiple lamps is decreased.

### BACKGROUND OF THE INVENTION

1. Field of the Invention

The present invention relates to a liquid crystal display device, and more particularly to a liquid crystal display device employing one or more cold cathode fluorescent tube type lamps having minimized power consumption and excellent brightness uniformity for displaying images with maximum light.

2. Description of the Related Art

In general, a cold cathode fluorescent tube type lamp is a lighting equipment for generating light. In the cold cathode fluorescent tube type lamp, light is generated by means of colliding electrons emitted from a cathode with fluorescent material without heating the cathode.

In particular, very large electric field is generated between the cathode and an anode in order to emit the electrons without heating the cathode of the cold cathode fluorescent tube type lamp. The electric field between the cathode and the anode is generated by means of a discharge voltage. The electrons emitted from the cathode by the discharge voltage moves to the anode. The electrons emitted from the cathode collide with discharging gas in a lamp tube of the cold cathode fluorescent tube type lamp, and then the discharging gas is dissociated to form plasma including discharging gas atoms, neutrons and electrons. Light is generated when the discharging gas is dissociated to form the plasma, the light is converted into visible light by means of the fluorescent material.

FIG. 1A is a schematic cross-sectional view illustrating the operation of a conventional cold cathode fluorescent tube type lamp, and FIG. 1B is a schematic circuit diagram showing the conventional cold cathode fluorescent tube type lamp in FIG. 1A.

In FIG. 1A, reference numeral “1” denotes a lamp tube. The lamp tube 1 has a transparent tube shape whose ends are sealed. Fluorescent material 3 is coated on the inner wall of the lamp tube 1. The fluorescent material 3 converts light generated from the plasma into visible light. In addition, discharging gas 5 is injected into the lamp tube 1, and the discharging gas 5 is dissociated by colliding with electrons as described above.

Meanwhile, a first electrode 7 and a second electrode 9 are positioned in the sealed lamp tube 1. The first electrode 7 is disposed opposite to the second electrode 9. In this case, the first electrode 7 is a cathode and the second electrode 9 is an anode.

The cold cathode fluorescent tube type lamp 10 has some advantages such as a low heating value, good light efficiency, and long durability. With those advantages, the cold cathode fluorescent tube type lamp 10 is widely used as a light supply device for a liquid crystal display device.

However, when two or more cold cathode fluorescent tube type lamps are connected to one voltage application device in parallel, those cold cathode fluorescent tube type lamps may not retain their advantages though the cold cathode fluorescent tube type lamp 10 has above-mentioned advantages when only one cold cathode fluorescent tube type lamp is installed in the liquid crystal display device.

Particularly, the light having high quality can be generated from one cold cathode fluorescent tube type lamp when one cold cathode fluorescent tube type lamp connected to one voltage application device is installed in the liquid crystal display device.

On the other hand, serious optical problems may occur between the cold cathode fluorescent tube type lamps in case that two or more cold cathode fluorescent tube type lamps connected to one voltage application device in parallel are installed in the liquid crystal display device.

Those optical problems are mainly caused by internal resistance of the cold cathode fluorescent tube type lamps that is inversely proportional to current externally supplied, as shown in FIG. 1B. Since the plasma is generated in the lamp tube 1, the internal resistance of the cold cathode fluorescent tube type lamps decreases according as the externally supplied current increases, while the internal resistance of the cold cathode fluorescent tube type lamps increases in accordance with the decrease of the externally supplied current.

Also, the optical problems may be caused by differences of electrical properties of the cold cathode fluorescent tube type lamps each having different current flow characteristics.

Considering the optical problems of the cold cathode fluorescent tube type lamps, the brightness of a cold cathode fluorescent tube type lamp having a good current flow characteristic gradually increases in accordance with the gradual decrease of the internal resistance of the cold cathode fluorescent tube type lamp corresponding to the gradual augmentation of the externally supplied current. On the other side, the internal resistance of a cold cathode fluorescent tube type lamp having poor current flow characteristic relatively increases corresponding to the decrease of the externally supplied current. When the liquid crystal display device includes such a cold cathode fluorescent tube type lamp, an image displayed on a screen of the liquid crystal display device may be partially invisible though the image is partially recognized on the screen.

### SUMMARY OF THE INVENTION

The present invention has been made to solve the aforementioned and other problems, and accordingly it is a first object of the present invention to provide a cold cathode fluorescent tube type lamp generating light demanded for displaying images with excellent minimized power consumption, and having superior brightness uniformity as well as good light efficiency for displaying images having high quality.

It is a second object of the present invention to provide a liquid crystal display device displaying a high quality image with at least one cold cathode fluorescent tube type lamp in accordance with an increase of a screen size on which an image is displayed without brightness non-uniformity, decrease of light efficiency and augmentation of power consumption of the cold cathode fluorescent tube type lamp when a plurality of cold cathode fluorescent tube type lamps are installed in the liquid crystal display device.

To achieve the above and other objects of the present invention, there is provided a cold cathode fluorescent tube type lamp which includes a tube body for receiving discharging gas, a fluorescent material layer coated on an inside surface of the tube body, a first electrode disposed on an outside surface of a first end portion of the tube body, and a second electrode disposed on an inner surface of a second end portion of the tube body, wherein the second electrode is disposed at a selected distance from the first electrode. The first electrode preferably includes an opening which has a size sufficient for light emitted from the tube body to pass through the opening without substantial loss of the light.

In another aspect of the present invention, there is provided a liquid crystal display device which comprises a lamp assembly including a) at least one cold cathode fluorescent tube type lamp for generating light, the cold cathode fluorescent tube type lamp having i) a tube body for receiving a discharging gas, ii) a fluorescent material layer coated on an inside surface of the tube body, iii) a first electrode disposed on an outside surface of a first end portion of the tube body, and iv) a second electrode disposed on an inner surface of a second end portion of the tube body, wherein the second electrode is disposed at a selected distance from the first electrode, and b) a voltage application device for providing a driving voltage to the cold cathode fluorescent tube type lamp through the first electrode, and a liquid crystal display panel assembly for modulating the light generated from the cold cathode fluorescent tube type lamp in response to an externally applied signal, and for displaying images on a display device.

According to the present invention, power consumption of the cold cathode fluorescent tube type lamp of the present invention can be minimized while the light efficiency of the cold cathode fluorescent tube type lamp of the present invention can be maximized. In addition, the brightness uniformity of the cold cathode fluorescent tube type lamps of the present invention can be improved when a plurality of the cold cathode fluorescent tube type lamps are employed.

### BRIEF DESCRIPTION OF THE DRAWINGS

The above and other objects and advantages of the present invention will become readily apparent by reference to the following detailed description when considered in conjunction with the accompanying drawings wherein:

FIG. 1A is a schematic cross-sectional view illustrating a conventional cold cathode fluorescent tube type lamp;

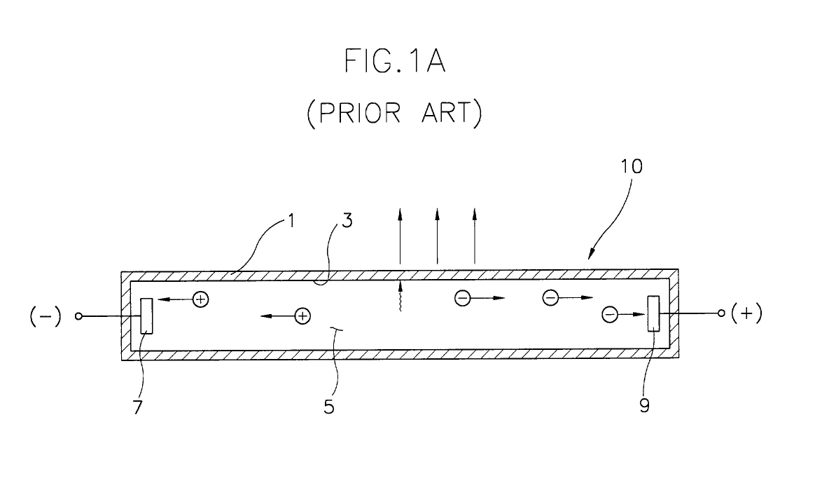

FIG. 1B is a schematic circuit diagram of the conventional cold cathode fluorescent tube type lamp in FIG. 1A;

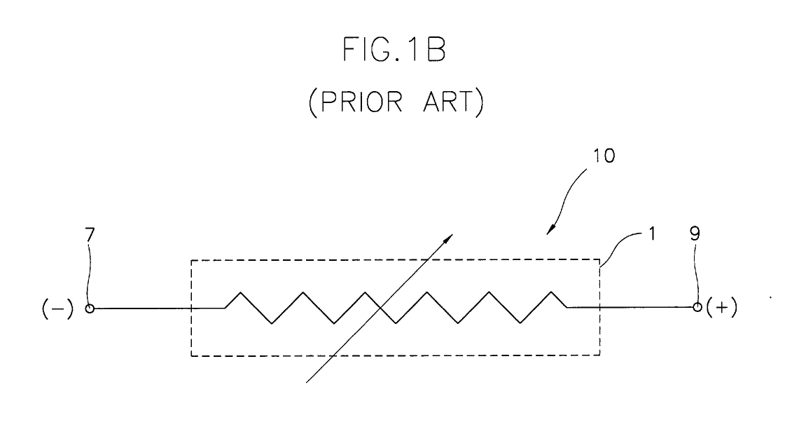

FIG. 2 is a perspective view illustrating a cold cathode fluorescent tube type lamp according to one embodiment of the present invention;

FIG. 3 is a cross-sectional view illustrating the cold cathode fluorescent tube type lamp taken generally along line III-III in FIG. 2;

FIG. 4 is an enlarged cross-sectional view showing ‘A’ in FIG. 3;

FIG. 5 is a perspective view illustrating a cold cathode fluorescent tube type lamp according to another embodiment of the present invention;

FIG. 6 is a cross-sectional view illustrating the cold cathode fluorescent tube type lamp taken along line VII-VII in FIG. 5;

FIG. 7 is a schematic diagram illustrating a connection between a cold cathode fluorescent tube type lamp and a voltage application device according to still another embodiment of the present invention;

FIG. 8 is a schematic diagram illustrating a connection between a cold cathode fluorescent tube type lamp and a voltage application device according to still another embodiment of the present invention;

FIG. 9 is a schematic diagram illustrating a connection between a plurality of cold cathode fluorescent tube type lamps and a voltage application device according to still another embodiment of the present invention;

FIG. 10 is a schematic cross-sectional view showing a liquid crystal display device according to one embodiment of the present invention; and

FIG. 11 is an exploded perspective view illustrating the liquid crystal display panel assembly in FIG. 10.

### DETAILED DESCRIPTION OF THE PREFERRED EMBODIMENTS

Hereinafter, a cold cathode fluorescent tube type lamp and a liquid crystal display device according to the preferred embodiments of the present invention will be described in detail with reference to the accompanying drawings.

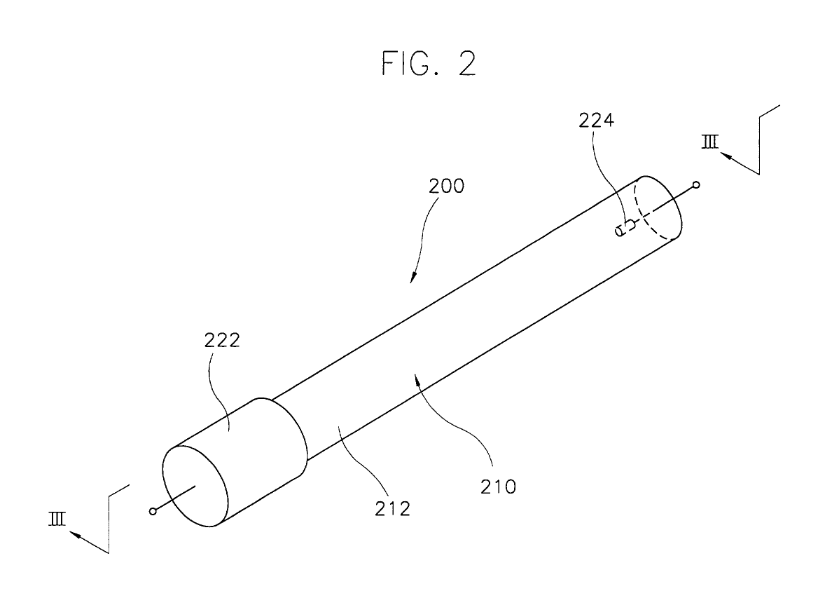

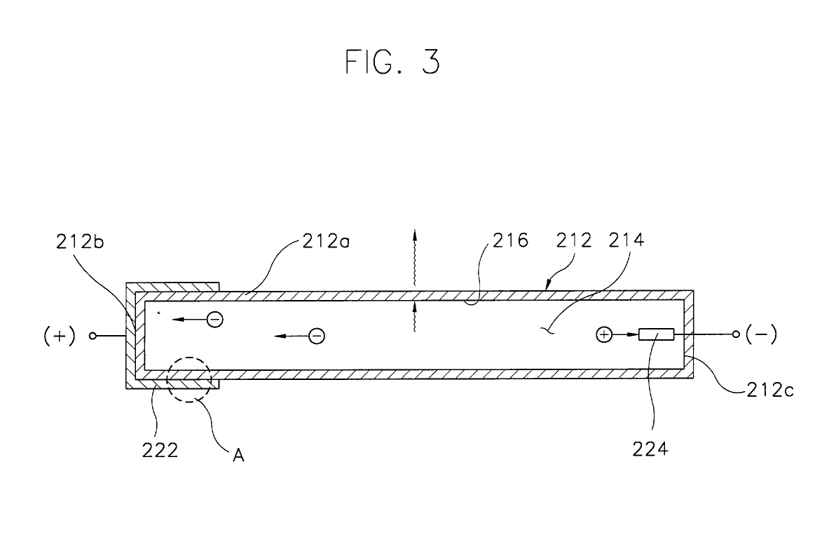

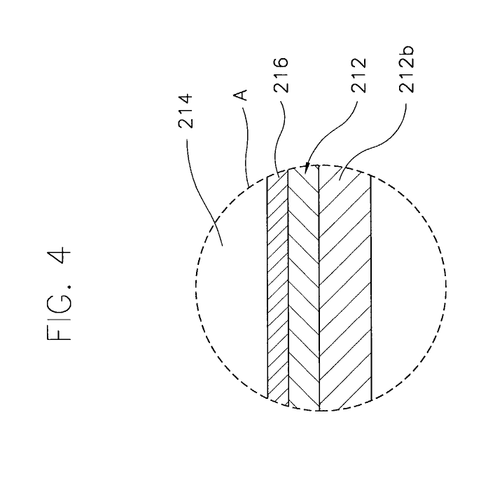

FIG. 2 is a perspective view showing a cold cathode fluorescent tube type lamp according to one embodiment of the present invention, and FIG. 3 is a cross-sectional view illustrating the cold cathode fluorescent tube type lamp taken generally along line III-III in FIG. 2. FIG. 4 is an enlarged cross-sectional view of portion “A” in FIG. 3.

Referring to FIGS. 2, 3 and 4, a cold cathode fluorescent tube type lamp 200 includes a tube body 212, a fluorescent material layer 216, a first electrode 222 and a second electrode 224.

The tube body 212 has a pertinent shape for sealing discharging gas. Preferably, the body 212 has a cylindrical shape whose ends are closed. Particularly, the tube body 212 has a circumferential portion 212a, a first end portion 212b and a second end portion 212c.

The discharging gas 214 is injected into the tube body 212 having the above-described structure. Fluorescent material is coated onto the inside surface of the circumferential portion 212a of the tube body 212 to form the fluorescent material layer 216 having a selected thin thickness.

To generate visible light from the fluorescent material layer 216 formed on the inside of the tube body 212 through the discharging gas 214 in the tube body 212, electrodes (e.g., first and second electrodes) are mounted in association with the tube body 212. In this case, the power consumption, the light efficiency and the bright uniformity of the cold cathode fluorescent tube type lamp 200 are under the great influence of position and arrangement of the electrodes. The light efficiency of the cold cathode fluorescent tube type lamp 200 can vary in relation to the position and arrangement of the first and second electrodes. Also, the brightness uniformity of the cold cathode fluorescent tube type lamp 200 can increase or decrease according to the position and arrangement of the first and second electrodes.

There are, for example, three types of arrangement of the first and second electrodes 222 and 224 disposed at the end portions of the tube body 212. The first type is that the first and second electrodes are disposed and arranged inside the tube body 212. In the second type, the first and second electrodes are disposed and arranged on the outside surface of the tube body 212. In the third type, one of the first and second electrodes 222 and 224 is disposed inside the tube body 212, and the other of the first and second electrodes 222 and 224 is disposed on the outside surface of the tube body 212, as shown in FIG. 3. Among those three types of the arrangement of the first and second electrodes, the third type in FIG. 3 has the best light efficiency and bright uniformity.

In a cold cathode fluorescent tube type lamp having the first type of the position and arrangement of the first and second electrodes, the bright uniformity of the cold cathode fluorescent tube type lamp may be seriously degraded when a plurality of cold cathode fluorescent tube type lamps are connected to one power source in parallel.

The light efficiency of the cold cathode fluorescent tube type lamp may be reduced when the cold cathode fluorescent tube type lamp has the second type of the position and arrangement of the first and second electrodes because the electrodes may block more light than those of a cold cathode fluorescent tube type lamp having the third type of the position and arrangement of the first and second electrodes may do. Also, the cold cathode fluorescent tube type lamp having the third type has the power consumption less than that of the cold cathode fluorescent tube type lamp having the second type of the position and arrangement of the first and second electrodes.

In the cold cathode fluorescent tube type lamp having the second type of the position and arrangement of the first and second electrodes, a capacitance may be generated by plasma between the conductive electrodes and the conductive sealing tube (that is, the dielectric tube body 212) because the two electrodes are disposed on the outside surface of the tube body 212. Thus, the equivalent circuit configuration of the cold cathode fluorescent tube type lamp having the second type is similar to a circuit in which a capacitance, a resistance (a discharge resistance) and another capacitance are connected to one after another in series. In this case, the power consumption of the cold cathode fluorescent tube type lamp having the second type is called first power consumption.

In the cold cathode fluorescent tube type lamp having the third type, however, only one electrode 222 of the two electrodes 222 and 224 is disposed on the outside surface of the tube body 212 as shown in FIG. 2 so that the equivalent circuit configuration of the cold cathode fluorescent tube type lamp having the third type is similar to that of a circuit in which a capacitance and a resistance are connected to each other in series. Hence, the capacitance of the cold cathode fluorescent tube type lamp having the third type is larger than that of the cold cathode fluorescent tube type lamp having the second type. Since the voltage for the discharge decreases as the capacitance increases, the voltage outputted from a transformer decreases so that the power consumption in the transformer is reduced. Therefore, second power consumption at the cold cathode fluorescent tube type lamp having the third type is lower than the first power consumption at the cold cathode fluorescent tube type lamp having the second type.

In the cold cathode fluorescent tube type lamp having the second type, the light is blocked more than that blocked by the electrodes of the cold cathode fluorescent tube type lamp having the third type in which only one of the two electrodes is disposed outside the tube body. This is because both the electrodes are disposed outside the tube body in the cold cathode fluorescent tube type lamp having the second type. Therefore, the light efficiency of the cold cathode fluorescent tube type lamp having the second type is lower than that of the cold cathode fluorescent tube type lamp having the third type.

Considering the above comparative description, in the cold cathode fluorescent tube type lamp 200 according to one preferred embodiment of the present invention, one electrode is disposed on the outside surface of the tube body and the other electrode is formed inside the tube body as shown in FIGS. 2 and 3.

Hereinafter, a detailed description of the position and arrangement of the first and second electrodes 222 and 224 for the cold cathode fluorescent tube type lamp 200 having the third type follows. It has been proved that this embodiment has excellent power consumption, good light efficiency and superior brightness uniformity.

In the present embodiment, the second electrode 224 is disposed inside the tube body 212 and the first electrode 222 is formed outside the tube body 212. The first electrode 222 is formed on one end portion of the tube body 212, and the second electrode 224 is disposed at the other end portion of the tube body 212. The first electrode 222 faces the second electrode 224, and the electrodes 222, 224 have a predetermined interval there between.

Particularly, the first electrode 222 contacts a first end face 212b of the tube body 212 and simultaneously contacts a first circumferential portion 212a of the tube body 212. That is, the first electrode 222 covers a first end portion of the tube body 212.

The cold cathode fluorescent tube type lamp 200 in FIGS. 2 and 3 may have lower light efficiency in comparison with a cold cathode fluorescent tube type lamp in which both the electrodes are disposed inside the tube body 212 because the first electrode 222 covers the end portion of the tube body 212.

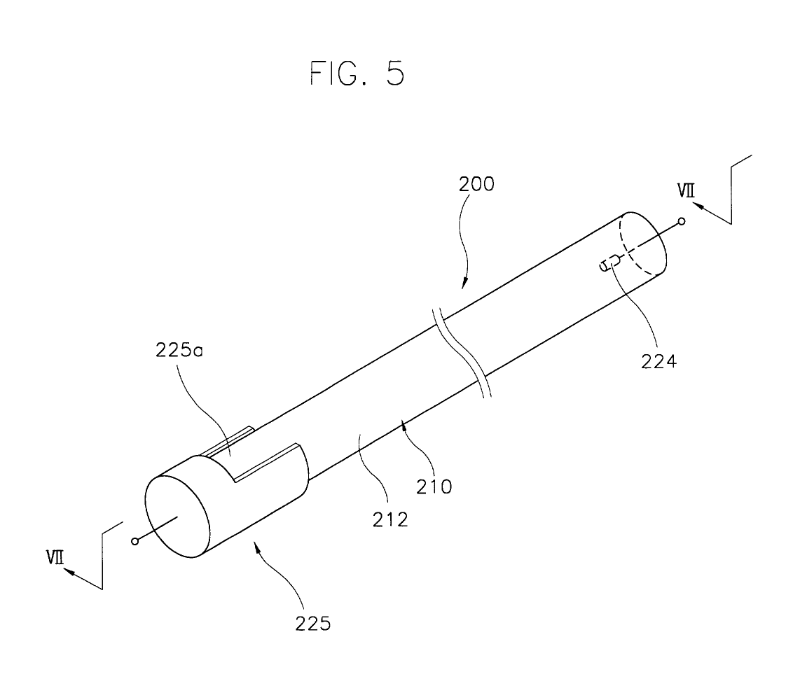

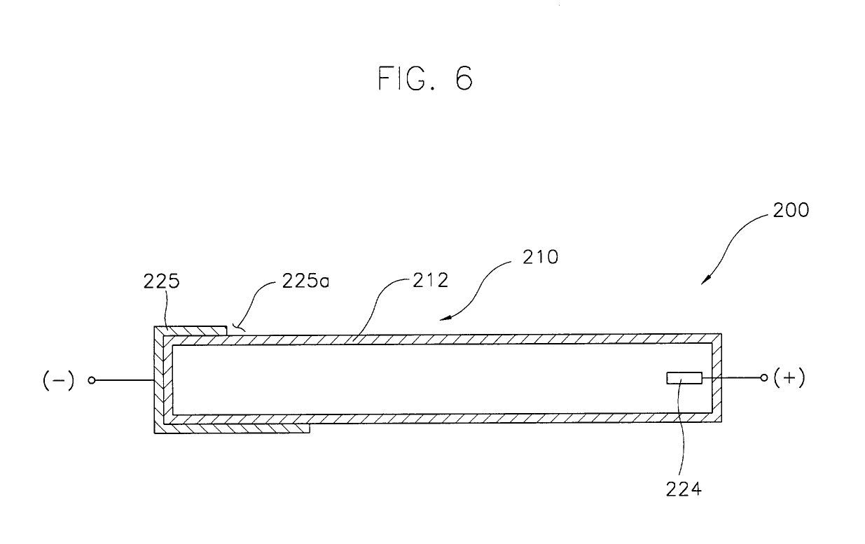

FIG. 5 is a perspective view showing a cold cathode fluorescent tube type lamp according to another embodiment of the present invention, and FIG. 6 is a cross-sectional view of the cold cathode fluorescent tube type lamp taken along line VII-VII in FIG. 5.

As shown in FIGS. 5 and 6, a cold cathode fluorescent tube type lamp according to another embodiment of the present invention has excellent light efficiency though a first electrode 225 is formed outside a tube body 212 and a second electrode 224 is disposed inside the tube body 212.

Referring to FIG. 6, the first electrode 225 is partially opened to form an opening 225a. In this case, the opening 225a of the first electrode 225 enables light to be supplied from the tube body 212 to emit toward the outside of the tube body without blocking the light by the first electrode 225.

Referring again to FIGS. 2 and 3, electrons should be emitted from one of the first and second electrodes 222 and 224, and should be moved in the tube body 212 to generate the light from the cold cathode fluorescent tube type lamp 200. In this case, a very high discharging voltage is applied to the first and second electrodes 222 and 224 to emit electrons from one of the first and second electrodes 222 and 224. Since it is difficult to directly apply the high discharging voltage to the electrodes 222 and 224 from the outside, a low voltage of approximately one to several tens volts is generally boosted to a high discharging voltage of several thousands volts to be applied to the electrodes 222 and 224.

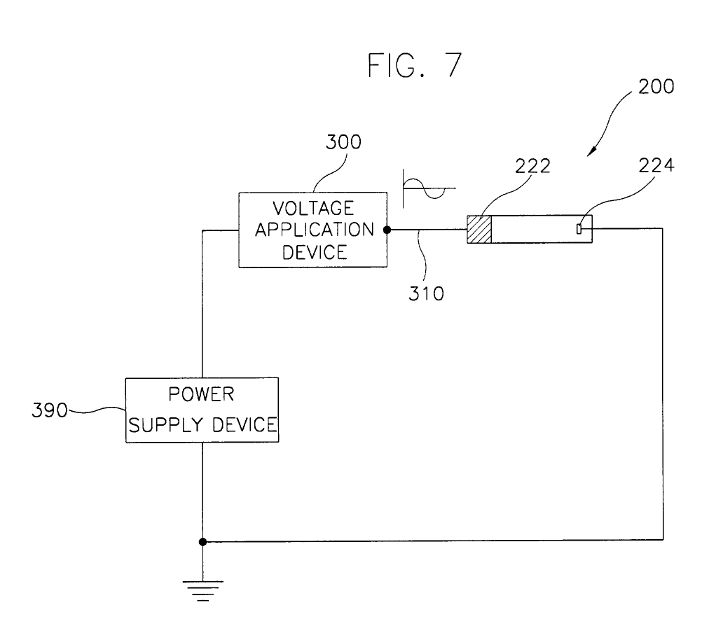

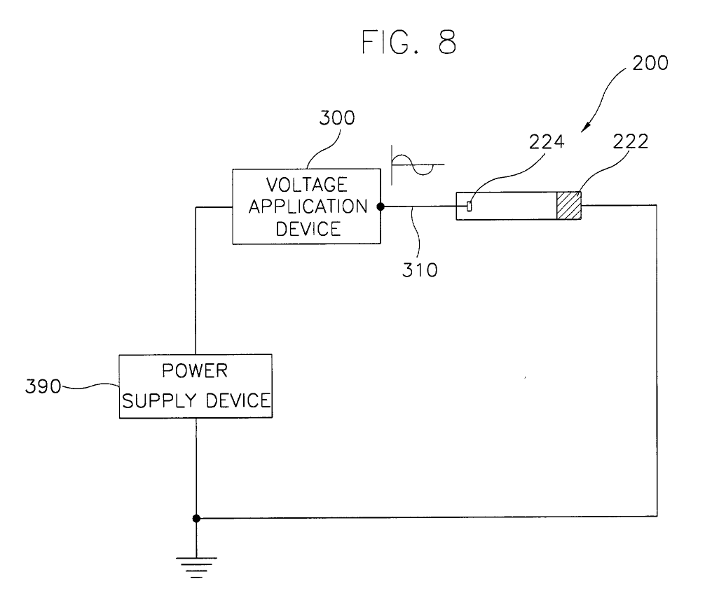

Thus, a voltage application device 300 is connected to the first and second electrodes 222 and 224 of the cold cathode fluorescent tube type lamp 200 as shown in FIGS. 7 and 8. The voltage application device 300 receives a low direct current voltage from a power supply device 390, and then converts the low direct current voltage into a high alternating current voltage. The voltage application device 300 includes an inverter and a transformer. The inverter controls a voltage boosted in the transformer.

The alternating current voltage boosted to several thousands volts is applied from an output terminal 310 of the voltage application device 300 to the cold cathode fluorescent tube type lamp 200. In this case, the alternating current voltage is applied to the first electrode 222 after the alternating current voltage is outputted from the output terminal 310 of the voltage application device 300 as shown in FIG. 7.

On the other hand, the alternating current voltage can be applied to the second electrode 224 after the alternating current voltage is outputted from the output terminal 310 of the voltage application device 300 as shown in FIG. 8. In this case, the power consumption and the heating value of the cold cathode fluorescent tube type lamp 200 may vary according as the alternating current voltage outputted from the output terminal 310 of the voltage application device 300 is applied to the first electrode 222 or the second electrode 224. The heating value of the cold cathode fluorescent tube type lamp 200 give an effect on the liquid crystal of a liquid crystal device in which the cold cathode fluorescent tube type lamp 200 is installed. A description of the configuration of the voltage application device 300 and the cold cathode fluorescent tube type lamp 200 follows.

Simulations are performed with respect to the cold cathode fluorescent tube type lamp 200 including the first electrode 222 formed outside the tube body 212 and the second electrode 224 disposed inside the tube body 212. In the simulations, the current in the tube body 212 is approximately 4 mA, and the driving frequency is approximately 60 kHz. Also, the length of the tube body 212 is approximately 378 mm, the diameter of the tube body 212 is approximately 2.6 mm, and the length of the first electrode 222 is approximately 17 mm.

With the cold cathode fluorescent tube type lamp 200 having above-mentioned dimensions, the power consumption is approximately 4.83W and the temperature difference between the first electrode 222 and the second electrode 224 is approximately 25° C. when the boosted high alternating current voltage is outputted from the output terminal 310 of the voltage application device 300 and is applied to the second electrode 224 of the cold cathode fluorescent tube type lamp 200 as shown in FIG. 8.

On the other hand, when the boosted high alternating current voltage is outputted from the output terminal 310 of the voltage application device 300 and then applied to the first electrode 222 of the cold cathode fluorescent tube type lamp 200 as shown in FIG. 7, the power consumption is approximately 4.33W and the temperature difference between the first electrode 222 and the second electrode 224 is approximately 10° C.

Light can be generated from the cold cathode fluorescent tube type lamp 200 when the alternating current voltage outputted from the output terminal 310 of the voltage application device 300 is applied to the first electrode 222 or the second electrode 224. However, as shown in the simulation results, the power consumption and the heating value vary depending on the connection between the output terminal 310 and one of the electrodes 222 and 224.

In one preferred embodiment of the present invention, the cold cathode fluorescent tube type lamp 200 includes the first electrode 222 formed on the outside surface of the tube body 212 and the second electrode 224 disposed inside the tube body 212, and the alternating current voltage is applied to the first electrode 222 of the cold cathode fluorescent tube type lamp 200 to reduce the power consumption and the temperature difference between the first electrode 222 and the second electrode 224.

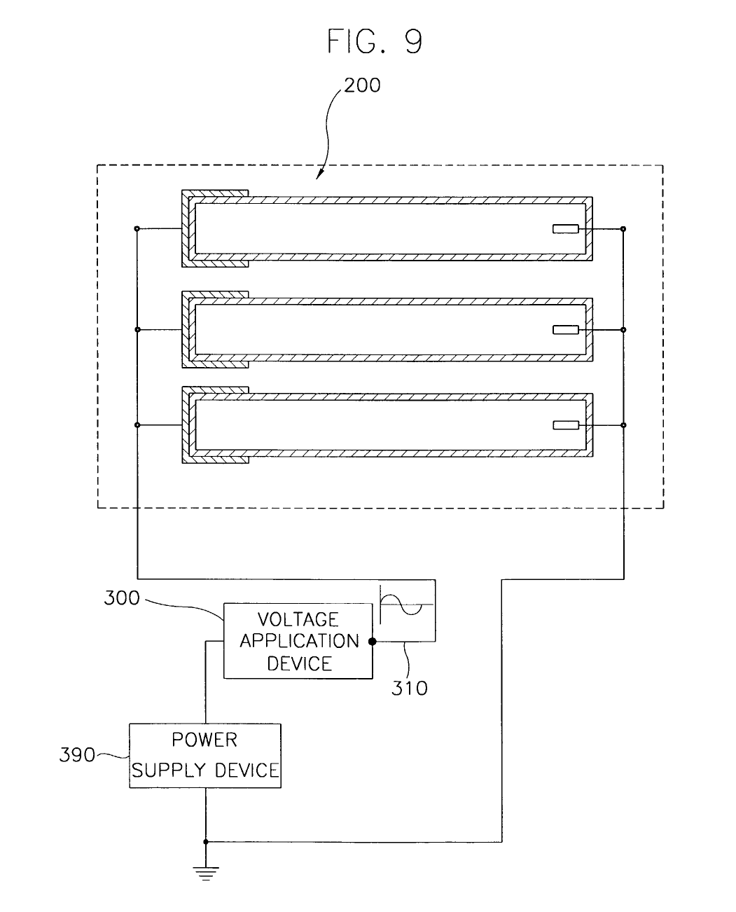

A plurality of cold cathode fluorescent tube type lamps 200 are parallelly connected to one voltage application device 300 according to another embodiment of the present invention as shown in FIG. 9. In this embodiment, the brightness uniformity of the cold cathode fluorescent tube type lamps 200 can be obtained though the cold cathode fluorescent tube type lamps 200 each have different current characteristics.

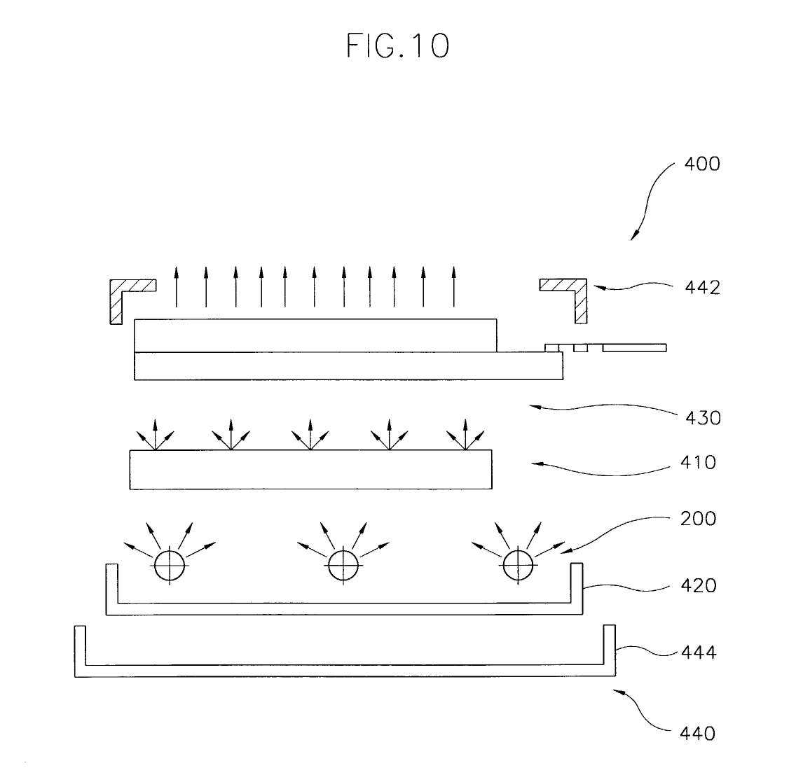

According to still another embodiment of the present invention, the cold cathode fluorescent tube type lamp 200 can be installed in a liquid crystal display device as shown in FIG. 10, thereby accomplishing high quality display on the liquid crystal display device.

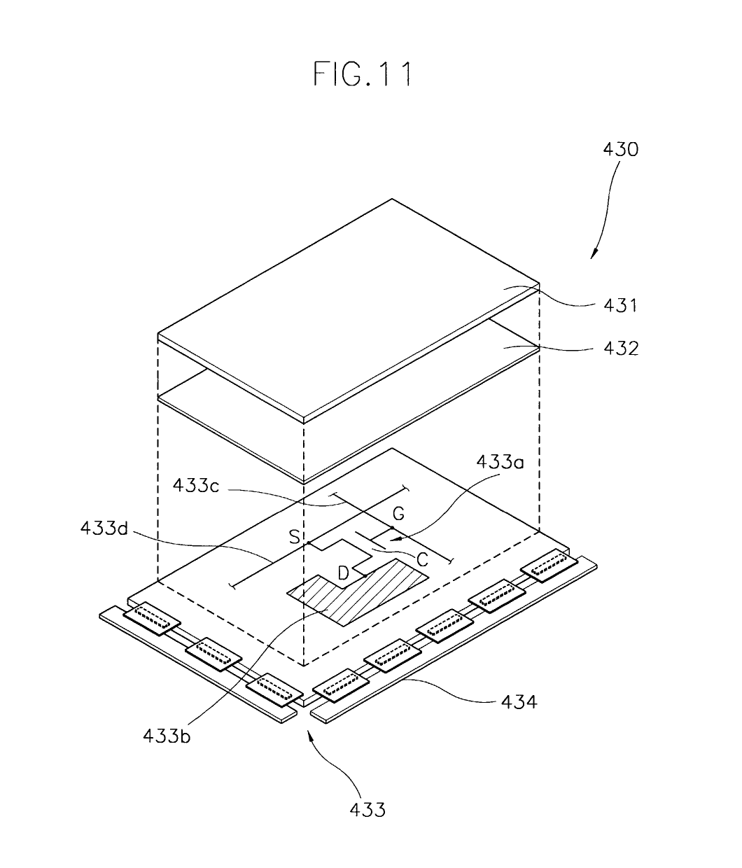

FIG. 10 is a schematic cross-sectional view illustrating the liquid crystal display device according to still another embodiment of the present invention, and FIG. 11 is an exploded perspective view showing a liquid crystal display panel assembly 430 in FIG. 10.

Referring to FIG. 10, the liquid crystal display device 400 generally includes at least one cold cathode fluorescent tube type lamp 200 and a liquid crystal display panel assembly 430. The liquid crystal display device 400 also includes a diffusion plate 410, a receiving container 420 and cases 440, 442 and 444 for high quality display.

The liquid crystal display panel assembly 430 has a color filter substrate 431, a liquid crystal 432, a thin film transistor (TFT) substrate 433 and a driving module 434 as shown in FIG. 11. The color filter substrate 431 includes red•green•blue (R•G•B) pixels and a common electrode. The R•G•B pixels are formed on one face of the color filter substrate 431. Those R•G•B pixels are arranged in a matrix form by means of the thin film technology. The R•G•B pixels having the matrix form filter white color light passing R•G•B pixels into one of red color light, green color light and blue color light.

The common electrode composed of indium tin oxide (ITO) is formed on the whole surface of the color filter substrate 431 where the R•G•B pixels are formed. It is noted that the common electrode may be made of other transparent conductive materials.

The TFT substrate 433 includes thin film transistors 433a, pixel electrodes 433b and signal applying lines 433c and 433d as shown in FIG. 11. In particular, a plurality of thin film transistors 433a are formed on one face of the TFT substrate 433 by employing a semiconductor technology. Those thin film transistors 433a are disposed in a matrix form. In this case, the number of the thin film transistors 433a is equal to that of the R•G•B pixels. The thin film transistors 433a each include a gate electrode G, a source electrode S, a drain electrode D and a channel region C.

In particular, the electrical property of the thin film transistor 433a is changed in the channel region C from conductive into nonconductive or from nonconductive into conductive. The channel region C is formed on the TFT substrate 433 according to one embodiment of the present invention. The gate electrode G is formed on the TFT substrate 433, and insulated from the channel region C. The source electrode S is electrically connected to one side of the channel region C with respect to the gate electrode G. The drain electrode D is electrically connected to the other side of the channel region C with respect to the gate electrode G.

A gate line 433c is connected to all of the gate electrodes G of the thin film transistors 433a arranged in the matrix form, and a data line 443d is connected to all the source electrodes S of the thin film transistors 433a. The driving module 434 is connected to the gate line 433c and the data line 433d to apply a driving signal to the thin film transistor 433a.

A pixel electrode 433b made of transparent conductive material such as ITO is formed in connection with the drain electrode D of the thin film transistor 433a. At this time, each pixel electrode corresponds to one of the R•G•B pixels of the color filter substrate 431.

The liquid crystal 432 is injected between the TFT substrate 433 and the color filter substrate 431 to form a liquid crystal layer. The light permeability of the liquid crystal layer varies with the electric field generated between the common electrode and the pixel electrode 433b.

The light generated from at least one cold cathode fluorescent tube type lamp 200 is provided to the liquid crystal display panel assembly 430 having the above-mentioned construction. As described above, one electrode of the cold cathode fluorescent tube type lamp 200 is disposed inside the tube, and the other electrode of the cold cathode fluorescent tube type lamp 200 is disposed outside the tube.

All the cold cathode fluorescent tube type lamps 200 are disposed in parallel, and receive the voltage from the voltage application device for display as shown in FIG. 10.

The cold cathode fluorescent tube type lamps 200 are fixed on a bottom face of the receiving container 420. The light generated from the cold cathode fluorescent tube type lamps 200 fixed on the bottom face of the receiving container 420 may have partially high brightness and/or partially low brightness so that the light may have irregular brightness distribution.

To solve the brightness non-uniformity of the light, the diffusion plate 410 diffusing the light is installed between the cold cathode fluorescent tube type lamps 200 and the liquid crystal display panel assembly 430. In this case, the diffusion plate 410 is installed on the receiving container 420, and the liquid crystal display panel assembly 430 is mounted on the diffusion plate 410.

As described above, the power consumption of the cold cathode fluorescent tube type lamp of the present invention can be minimized while the light efficiency of the cold cathode fluorescent tube type lamp of the present invention can be maximized.

Also, the brightness uniformity of light from the cold cathode fluorescent tube type lamps of the present invention can be improved when a plurality of the cold cathode fluorescent tube type lamps are employed.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A cold cathode fluorescent tube type lamp comprising:
a tube body for receiving discharging gas;
a fluorescent material layer coated on an inside surface of said tube body;
a first electrode disposed on a first selected area outside said tube body; and
a second electrode disposed at a second selected area inside said tube body, wherein said second electrode is disposed at a selected distance from said first electrode.

2. The cold cathode fluorescent tube type lamp of claim 1, wherein said first electrode covers a first end portion of said tube body and an outer portion of said tube body adjacent to said first end portion of said tube body.

3. The cold cathode fluorescent tube type lamp of claim 2, wherein an opening is formed at a selected portion of said first electrode, said opening being placed in a light emitting direction.

4. The cold cathode fluorescent tube type lamp of claim 3, wherein said opening has a size sufficient for light emitted from said tube body to pass through said opening without substantial loss of said light.

5. The cold cathode fluorescent tube type lamp of claim 2, wherein said first electrode covers said outer portion of said tube body by an identical distance from said first end portion of said tube body.

6. The cold cathode fluorescent tube type lamp of claim 1, wherein an alternating current is applied to said first electrode.

7. The cold cathode fluorescent tube type lamp of claim 1, wherein said first selected area is an outside surface of one of end portions of said tube body.

8. The cold cathode fluorescent tube type lamp of claim 7, wherein said second selected area is an inner surface of the other of said end portions of said tube body.

9. A liquid crystal display device comprising:
a lamp assembly including:
at least one cold cathode fluorescent tube type lamp for generating light, said at least one cold cathode fluorescent tube type lamp having:
a tube body for receiving a discharging gas;
a fluorescent material layer coated on an inside surface of said tube body;
a first electrode disposed on a first selected area outside said tube body; and
a second electrode disposed at a second selected area inside said tube body, wherein said second electrode is disposed at a selected distance from said first electrode; and
voltage application means for providing a driving voltage to said at least one cold cathode fluorescent tube type lamp through said first electrode; and
a liquid crystal display panel assembly for modulating said light generated from said at least one cold cathode fluorescent tube type lamp in response to an externally applied signal, and for displaying images on a display device.

10. The liquid crystal display device of claim 9, wherein said at least one cold cathode fluorescent tube type lamp includes a plurality of cold cathode fluorescent tube type lamps which are disposed in parallel to each other.

11. The liquid crystal display device of claim 10, wherein said driving voltage is applied to said first electrode of each of said plurality of cold cathode fluorescent tube type lamps.

12. The liquid crystal display device of claim 11, wherein said driving voltage is an alternating current voltage.

13. The liquid crystal display device of claim 9, wherein said first selected area is an outside surface of one of end portions of said tube body.

14. The liquid crystal display device of claim 13, wherein said second selected area is an inner surface of the other of said end portions of said tube body.

15. The liquid crystal display device of claim 9, wherein said voltage application means has an inverter and a transformer for boosting a voltage in response to a control signal generated from said inverter, said boosted voltage being provided to said first electrode.
